(19) United States
(12) Patent Application Publication
(10) Pub. No.: US 2026/0295477 A1
(43) Pub. Date: Oct. 1, 2026

(54) MAGNETICALLY-COUPLED FILTRATION SYSTEM

(71) Applicant: Daniel Mitton, Wellsville, UT (US)

(72) Inventor: Daniel Mitton, Wellsville, UT (US)

(21) Appl. No.: 19/096,397

(22) Filed: Mar. 31, 2025

Related U.S. Application Data
(60) Provisional application No. 63/548,583, filed on Feb. 1, 2024.

(51) Int. Cl. B01D 29/64; B01D 29/15; B01D 29/23

(52) U.S. Cl. CPC B01D 29/6484; B01D 29/15; B01D 29/23

(57) ABSTRACT

A filtration system includes a filter structure forming an inner channel. The filter structure is to remove solid matter from liquid. The filtration system further includes a lid structure including first and second ports. The filtration system further includes a housing structure forming an inner volume. The filter structure is disposed in the inner volume. The housing structure includes a distal end to releasably attach to the lid structure. The filtration system further includes an actuation structure to be moved relative to the housing structure. The actuation structure includes one or more metallic components. The filtration system further includes an agitator structure disposed in the housing structure. The agitator structure and the actuation structure are magnetically attracted to each other. The agitator structure is to remove the solid matter from the filter structure responsive to the actuation structure being moved relative to the housing structure.

### RELATED APPLICATION

This application claims benefit of U.S. Provisional App. No. 63/548,583, filed Feb. 1, 2024, the contents of which are incorporated by reference in their entirety.

### BACKGROUND

Filtration can be used to separate materials. A filter may not allow solid matter to pass and may allow the liquid to pass. Filters are to be cleaned so that solid matter does not build up on the filters and restrict liquid flow through the filters.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIGS. 1A-C illustrate filtration systems, according to certain embodiments.

FIGS. 2A-E illustrate components of filtration systems, according to certain embodiments.

FIGS. 3A-C illustrate filtration systems, according to certain embodiments.

FIGS. 4A-B illustrate agitator structures of filtration systems, according to certain embodiments.

### DETAILED DESCRIPTION

The present disclosure is associated with a magnetically-coupled filtration systems.

Filtration can be used to separate solid matter from a liquid. A filter may not allow solid matter to pass and may allow the liquid to pass. Filters are to be cleaned so that solid matter does not build up on the filters and restrict liquid flow through the filters.

Irrigation (e.g., watering of plants) is the practice of applying controlled amounts of water to land to help grow crops, landscape plants, lawns (e.g., grass), etc. Irrigation helps to grow crops, maintain landscapes, and revegetate disturbed soils in dry areas and during times of below-average rainfall. Irrigation can also be used to protect crops from frost, suppress weed growth in grain fields, and prevent soil consolidation. Irrigation can be used to cool livestock, reduce dust, dispose of sewage, and support mining operations. Irrigation may include surface irrigation (e.g., gravity irrigation), sprinkler irrigation (e.g., water is piped to locations within a filed and distributed by high pressure water devices), micro-irrigation (e.g., distribute water under low pressure through a piped network and applied as a small discharge to each plant), drip irrigation (e.g., deliver water directly to the root zone of plants), etc.

Irrigation water can come from groundwater (e.g., extracted from springs, using wells, etc.), from surface water (e.g., rivers, lakes, reservoirs), and/or from non-conventional sources (e.g., treated wastewater, desalinated water, drainage water, fog collection).

Liquids (e.g., used in irrigation) may include solid matter (e.g., solid particles, algae, shells, etc.). The solid matter in liquids may have negative effects. Solid matter in liquids may clog systems and components and/or may cause damage to downstream components (e.g., sprinkler heads, piping, etc.). Solid matter can be harmful for recipients of the liquid (e.g., plants, animals, humans, etc.).

Filters may be used to remove solid matter. Solid matter may build up on filters and restrict (e.g., prevent) liquid flow through the filters. Filters are to be periodically cleaned. Conventionally, a user is to access the filter (e.g., open a valve box, dig to access the filter, etc.), disassemble the filtration system to remove the filter, clean the filter (e.g., using specialized tools), reassemble the filtration system, and close the access (e.g., close the valve box, re-bury the filter, etc.). This process may take place in environments that are wet, muddy, and/or difficult to access (e.g., small area) which makes cleaning filters very difficult. Because of these difficulties, filters may be cleaned less often than the filters should be, filters may not be thoroughly cleaned, components may become dirty and/or lost, specialized service providers may be required, extensive user time may be used, etc.

The systems, devices, components, and methods disclosed herein solve shortcomings of conventional solutions.

A filtration system of the present disclosure includes a filter structure forming an inner channel (e.g., a cylindrical filter structure that has a substantially constant circular outer perimeter and a substantially constant circular inner perimeter from a first distal end to a second distal end of the filter structure). The filter structure is to remove solid matter from liquid.

The filtration system of the present disclosure further includes a lid structure including first and second ports (e.g., inlet and outlet).

The filtration system further includes a housing structure forming an inner volume. The filter structure is disposed in the inner volume. The housing structure includes a first distal end to releasably attach to the lid structure. The housing structure may include a second distal end configured to releasably attach to an outlet structure (e.g., the outlet structure may be removed to drain filtered solid material from the filtration system).

The filtration system of the present disclosure further includes an actuation structure to be moved relative to the housing structure. The actuation structure includes one or more metallic components. The filtration system further includes an agitator structure disposed in the housing structure. In some embodiments, the actuation structure is disposed around the housing structure and the agitator structure is configured to clean an outside surface of the filter structure. In some embodiments, the actuation structure is at least partially disposed in a channel portion of the lid structure (e.g., extends into the inner channel of the filter structure) and the agitator structure is disposed in the filter structure and is configured to clean an inside surface of the filter structure.

The agitator structure and the actuation structure are magnetically attracted to each other. The agitator structure is to remove the solid matter from the filter structure responsive to the actuation structure being moved relative to the housing structure.

In some embodiments, the filtration system uses a magnetically coupled agitator structure (e.g., mixer) and actuation structure (e.g., handle) to remove solid material from a filter structure. A magnetically coupled actuation structure (e.g., handle) and agitator structure can remove solid matter from the filter structure by magnetically coupling the agitator structure (located in the housing structure) and the actuation structure (e.g., handle, separated from the liquid) and pumping the actuation structure (e.g., handle) up and down along a major axis of the housing structure (e.g., vessel) without shaking the housing structure (e.g., vessel). In some embodiments, the pumping action to remove solid matter from the filter structure is done while holding the housing structure (e.g., vessel) in one hand and pumping the actuation structure/agitator structure (e.g., handle/agitator) with the other hand.

The present disclosure has advantages over conventional solutions. The present disclosure may be used to better clean and more regularly clean filter structures than conventional solutions. The present disclosure may have less clogs and cause less damage to components than conventional solutions. The present disclosure may cause the system (e.g., irrigation system) to work better (e.g., provide better irrigation to plants) than conventional solutions. The present disclosure may provide easier, less-error prone, and less timely cleaning of filter structures than conventional solutions.

The present disclosure also has the benefit of using magnets with liquid (e.g., water, reclaimed water, irrigation water, secondary water, mixtures, etc.) to provide a better liquid than conventional solutions. Water (H2O) is made of bonded hydrogen and oxygen. Typically, H2O groups together in clusters of molecules (e.g., 10-12 molecules). These clusters are held together by surface tension. The use of magnets by the present disclosure may affect this surface tension, breaking up the clusters of molecules into smaller clusters (e.g., clusters of 6-7 molecules). Magnets of the present disclosure may create a magnetic field that spreads the de-clustering to all groups of molecules that pass within the field. The one or more magnets of the present disclosure may de-cluster the water molecules and ionize the water molecules to be more alkaline. This may provide improved hydration (e.g., magnets make water “wetter” by breaking down the H2O cluster size, smaller molecules are readily absorbed by organisms (e.g., plants) allowing to hydrate quicker and more thoroughly). This also may provide better bio-availability (e.g., smaller molecule size and easy absorption is called “bioavailability,” this is also handy for absorbing whatever healthy nutrients the fluid is carrying).

Magnetizing liquid and magnetized liquid may refer to liquid having been subjected to a magnetic field which has changed certain properties of that liquid.

Magnets of the filtration system of the present disclosure may provide a magnetized water which is a more alkaline water and which may raise the pH of organisms (e.g., plants) to better allow organisms to get rid of toxins compared to conventional solutions. Bio-magnetized water of the filtration system of the present disclosure may be energy-building, activating, cleansing, and detoxifying.

The filtration system of the present disclosure may provide magnetized liquids (e.g., bi-polar magnetized liquids treated with both North and South poles) and may better reduce plant sickness, increase cell membrane permeability, increase plant growth, and/or the like compared to conventional solutions. Magnetized water of the filtration system of the present disclosure may be wetter and more penetrating than conventional solutions. This may further better assimilation of various nutrients and vitamins in the cells.

Although some embodiments of the present disclosure are described in relation to benefits of magnetizing water via filtration systems for irrigation use, embodiments of the present disclosure may be used for benefits of magnetizing materials other than water (e.g., other liquids, mixtures, etc.) and/or for magnetizing materials (e.g., liquids) for uses other than irrigation (e.g., animal consumption, providing to people, etc.).

Although some embodiments of the present disclosure refer to using the filtration system to clean an inner surface or an outer surface of a filter structure, the present disclosure may also be used to clean other components and/or surfaces of the filtration system, to provide mixing (e.g., of liquids and/or solids), etc.

Although some embodiments of the present disclosure refer to using the filtration system to remove solid matter from liquid, in some embodiments, the present disclosure may be used to remove a portion of solid matter from liquid, remove viscous matter from liquid, remove liquid from liquid, remove liquid from solid, and/or the like.

Although some embodiments of the present disclosure refer to filtration for irrigation systems, the present disclosure may be used in relation to filtration associated with food, beverages, manufacturing, waste processing, etc.

Although some embodiments of the present disclosure refer to the actuation structure of the filtration system being actuated by a user to move the agitator structure, in some embodiments, the agitator structure is moved automatically (e.g., an electromagnet, the actuation structure is coupled to a motor that moves the actuation structure and agitator structure).

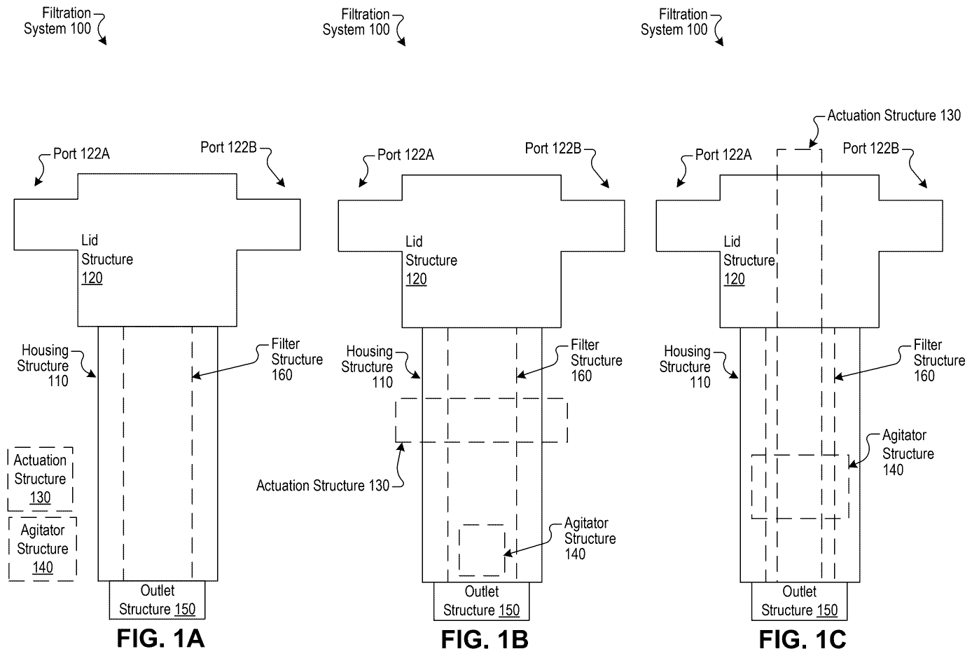

FIGS. 1A-C illustrate filtration systems 100, according to certain embodiments. One or more of the components or features of FIGS. 1A-C, 2A-E, 3A-C, and/or 4A-B that have similar names and/or reference numbers may have similar functionality, materials, structure, and/or the like.

Referring to FIGS. 1A-C, a filtration system 100 may include a housing structure 110, a lid structure 120, an actuation structure 130, an agitator structure 140, outlet structure 150, and/or filter structure 160. In some embodiments, the filtration system 100 is all new components. In some embodiments, at least the actuator structure 130 and agitator structure 140 are added to an existing housing structure 110 (e.g., and an existing lid structure 120, outlet structure 150, and/or filter structure 160). At least the actuator structure 130 and agitator structure 140 can be used to retrofit a conventional filtration system.

The filter structure 160 may form an inner channel (e.g., filter structure 160 is a hollow cylinder, the filter has substantially constant circular outer and inner diameters). The filter structure 160 may be configured to remove solid matter from liquid. The filter structure 160 may include a frame (e.g., for structure) and a filter (e.g., to remove objects of a threshold size).

The lid structure 120 may include ports 122A-B. In some embodiments, port 122A is an inlet and port 122B is an outlet. In some embodiments, port 122B is an inlet and port 122A is an outlet.

The housing structure 110 forms an inner volume. The filter structure 160 is disposed in the inner volume. The housing structure 110 includes a first distal end configured to releasably attach to the lid structure. and a second distal end configured to releasably attach to outlet structure 150.

The actuation structure 130 is configured to be moved (e.g., by a user, by a motor) relative to the housing structure 110. The actuation structure 130 includes one or more metallic components (e.g., magnetic component(s)).

The agitator structure 140 is disposed in the housing structure 110. The agitator structure 140 and the actuation structure 130 are magnetically attracted to each other. The agitator structure 140 is configured to remove the solid matter from the filter structure 160 responsive to the actuation structure 130 being moved relative to the housing structure 110.

Liquid may enter one of the ports 122 of the lid structure 120, flow through the filter structure 160 in the housing structure 110, and flow out the other port 122. The filter structure 160 prevents the flow of solid matter and allows flow of liquid. The actuation structure 130 is moved relative to the housing structure 110 (e.g., without being in the liquid) which causes the agitator structure 140 to move along the filter structure 160 to remove the solid material. In some embodiments, the outlet structure 150 is removed from the housing structure 110 and the solid material exits the filtration system 100.

In some embodiments, a processing device causes the actuation structure 130 to move relative to the housing structure 110 to clean the filter structure 160 via the agitator structure 140. The processing device may cause the outlet structure 150 (e.g., a valve) to open to allow the solid matter to exit the filtration system 100.

Referring to FIG. 1B, in some embodiments, the actuation structure 130 extends around the housing structure 110. The actuation structure 130 and the agitator structure 140 are magnetically attracted to each other. As the actuation structure 130 is moved up and down around the housing structure 110, the agitator structure 140 is moved up and down in the housing structure 110 to remove the solid matter from the filter structure 160.

Referring to FIG. 1C, in some embodiments, the actuation structure 130 extends into the lid structure 120 and/or housing structure 110. The actuation structure 130 and the agitator structure 140 are magnetically attracted to each other. As the actuation structure 130 is moved up and down in the lid structure 120 and/or housing structure 110, the agitator structure 140 is moved up and down in the housing structure 110 to remove the solid matter from the filter structure 160.

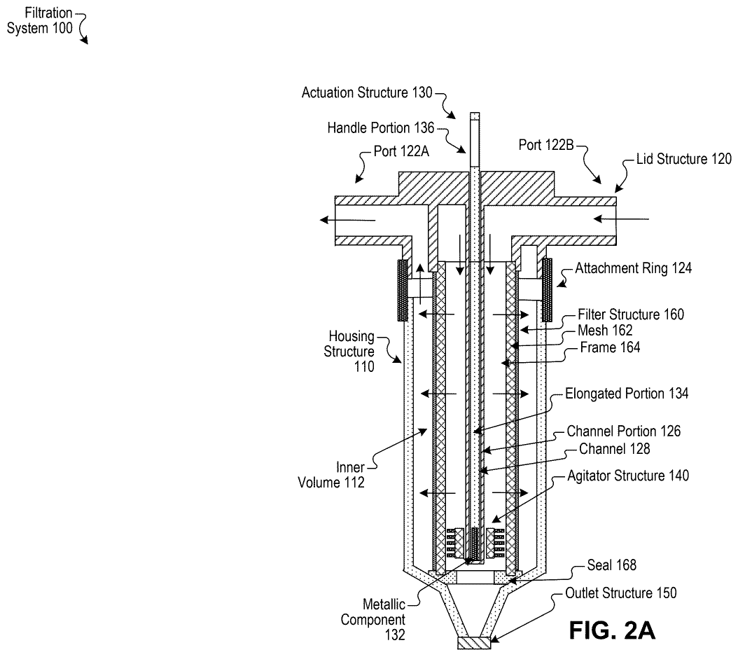

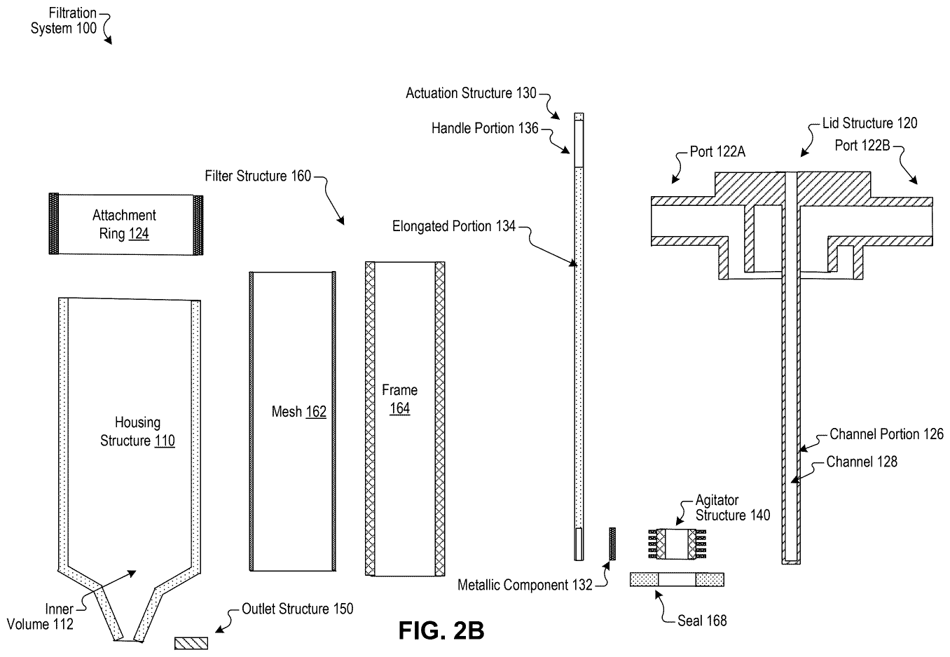

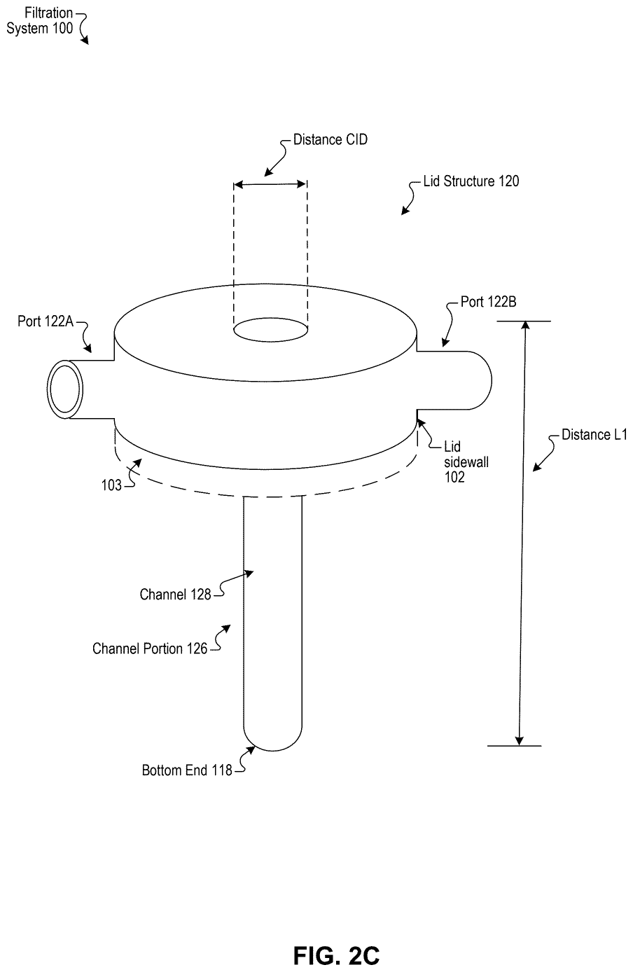

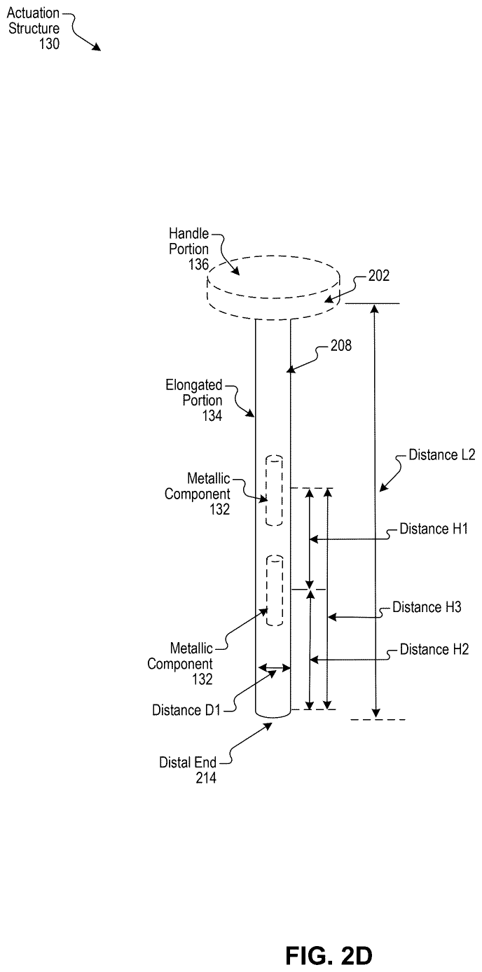

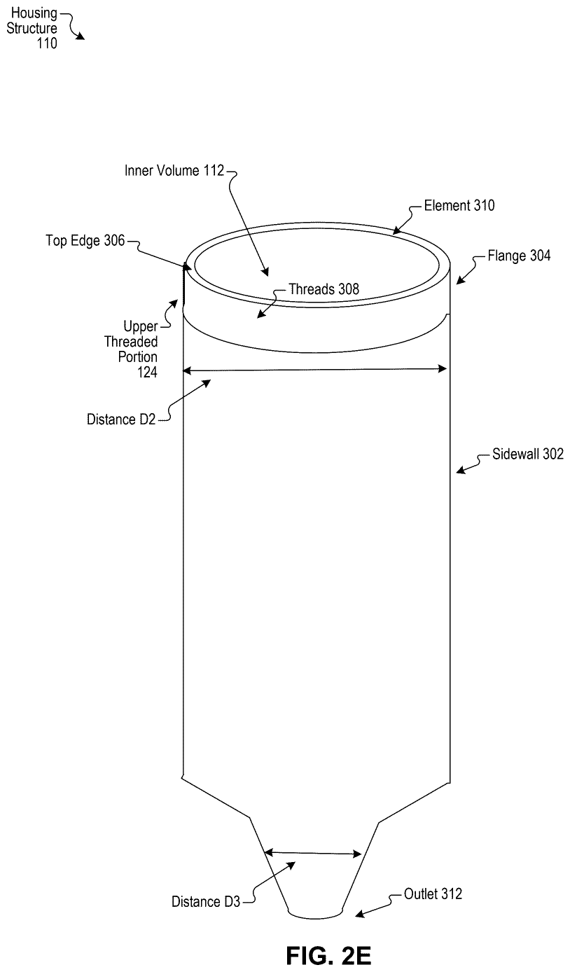

FIGS. 2A-E illustrate components of filtration systems 100, according to certain embodiments. FIG. 2A illustrates a filtration system 100 that is assembled, according to certain embodiments. FIG. 2B illustrates a filtration system 100 that is disassembled, according to certain embodiments. FIG. 2C illustrates the lid structure 120, according to certain embodiments. FIG. 2D illustrates the actuation structure 130. FIG. 2E illustrates the housing structure 110, according to certain embodiments.

Referring to FIGS. 2A-B, filtration system 100 includes a housing structure 110 forming an inner volume 112. Housing structure 110 may include an upper portion that has a substantially equal outer diameter. Housing structure 110 may include a lower portion that is tapered. The first and second distal ends of housing structure 110 may be threaded. Sidewalls of the housing structure 110 may have a substantially equal thickness.

Filtration system 100 includes a lid structure 120 configured to couple to the housing structure 110. Lid structure 120 may include a bottom portion that is threaded. In some embodiments, the lid structure 120 is directed attached to the housing structure 110 via threading. In some embodiments, lid structure 120 is attached to attachment ring 124 via threading and the attachment ring 124 is attached to housing structure 110 via threading (e.g., lid structure 120 is attached to housing structure 110 via attachment ring 124). Lid structure 120 may include ports 122A-B (e.g., inlet and outlet). The lid structure 120 may include concentric flow paths. Port 122A may be fluidly coupled to the housing structure 110 via an outer flow path and port 122B may be fluidly coupled to the housing structure 110 via an inner flow path. Lid structure may include a channel portion 126 that forms a channel 128. The channel portion 126 may be configured to extend into the housing structure 110 (e.g., and into the filter structure 160).

Filtration system 100 includes an actuation structure 130 disposed in the channel 128 formed by the channel portion 126 of the lid structure 120. Actuation structure 130 may include a handle portion 136 (e.g., configured to be gripped by a user, configured to be coupled to a motor) configured to be used to move the actuation structure 130 relative to the housing structure 110. Actuation structure 130 further includes an elongated portion that extends into the channel 128 formed by channel portion 126 of the lid structure 120. At least one metallic components 132 (e.g., magnets) is disposed in a distal end (e.g., in a recess formed by the distal end) of the elongated portion 134. In some embodiments, responsive to the actuation structure 130 being disposed in the channel portion 126, the handle portion 136 is at least partially disposed outside of the channel portion 126 (e.g., at least partially protrudes from the lid structure 120). In some embodiments, the handle portion 136 is disposed in the lid structure 120 and the lid structure 120 forms a recess proximate the handle portion 136 for a user to insert one or more fingers to grip the handle portion 136.

Filtration system 100 includes an agitator structure 140 disposed around the channel portion 126. Agitator structure 140 includes metal (e.g., one or more magnets). Agitator structure has an inner perimeter that is larger than (e.g., substantially matches) the outer perimeter of the channel portion 126. Agitator structure 140 includes protrusions that extend towards the inner surface of filter structure 160. The protrusions may be metal, plastic, rubber, flexible, rigid, and/or the like.

Filtration system 100 includes an outlet structure 150 disposed at a distal end of housing structure 110. The outlet structure 150 may block the liquid and/or solid matter from exiting the distal end of the housing. The outlet structure 150 may be removed and/or actuated to an open position to allow solid matter to exit the housing structure 110 (e.g., responsive to the actuation structure 130 moving the agitator structure 140 within the filter structure 160).

Filtration system 100 includes a filter structure 160. Filter structure 160 may by cylindrical and may form an inner channel. The outer and inner diameters of the filter structure 160 may be substantially constant. The filter structure 160 may include a mesh 162 (e.g., opening size determines what size of particles can pass through the mesh 162 and what size of particles cannot pass through the mesh 162, 32-mesh screen, 100-mesh screen) and a frame 164 (e.g., to provide rigidity to the filter structure 160 to prevent the filter structure 160 from collapsing under pressure from liquid and/or solid matter. A first distal end of filter structure 160 (e.g., frame 164) may be configured to couple with lid structure 120 (e.g., via threading, via friction fit) and a second distal end of filter structure 160 (e.g., frame 164) may be configured to couple with seal 168. Seal 168 may seal the second distal end of filter structure 160 with the inner surface of the housing structure 110 so that solid matter that entered via port 122B and that was filtered by the filter structure 160 does not exit the filtration system 100 via port 122A (e.g., instead, the solid matter is to exit the filtration system 100 via housing structure 110 responsive to outlet structure 150 being removed from housing structure 110.

Responsive to a liquid-solid mixture entering the filtration system 100 via port 122B and entering the inner channel formed by the filter structure 160, the solid matter remains in the inner channel of the filter structure 160, and the liquid passes through the filter structure 160 and exits the filtration system 100 via port 122A. The actuation structure 130 and the agitator structure 140 are magnetically coupled and responsive to the actuation structure 130 being moved, the agitator structure 140 moves along the filter structure 160 to clean the filter structure 160 (e.g., remove solid matter from an inner surface of filter structure 160). The outlet structure 150 is removed or opened and the solid matter exits the filtration system 100.

In some embodiments of the present disclosure a filtration system 100 includes a housing structure 110 (e.g., vessel) contains a filter structure 160 fitted to the lid structure 120 (e.g., vessel lid), and the lid structure 120 (e.g., vessel lid) is configured to pass an inward flow of water through the lid structure 120 (e.g., vessel lid) to the filter structure 160, trapping sediment in the housing structure 110 (e.g., vessel) with the filter structure 160. Thus, the flow of water exits the housing structure 110 (e.g., vessel) from the filter structure 160 to a port 122 (e.g., an outlet) in the lid structure 120 (e.g., vessel lid). In some embodiments, the filtration system 100 (e.g., filtration assembly) is used in farming irritation lines, where the water passing through the filter structure 160 from a “dirty” source (such as a well or canal) contains debris which are removed from the flow of water by the filter structure 160 in the filtration system 100 (e.g., filtration assembly). The water exiting the filtration system 100 (e.g., filter assembly) is directed to components (e.g., irrigation sprinklers) to be sprayed onto plants (e.g., a field of crops).

Filtration assemblies are periodically cleaned to remove the debris from the filter in the filtration assembly, promoting smooth flow of water through the filtration assembly. Conventionally, it is a time-consuming process to open a conventional filtration assembly to expose the filter and brush the filter to remove debris from the filter, or to brush the filter to remove sediment which has adhered to the filter and, in some instances, partially or completely blocked the flow of water through the filter. A conventional filtration assembly may leak after the filter is cleaned and the filtration assembly is put back together. The person who cleans the filter are also prone to getting wet from the water in the filtration assembly.

In some embodiments, the filtration system 100 (e.g., filtration assembly) of the present disclosure does not need to be disassembled to clean the filter structure 160 which reduces the amount of time used to clean filters compared to conventional irrigation filtration assemblies. In some embodiments, the filtration system 100 (e.g., filtration assembly) can be flushed without removing the housing structure 110 (e.g., outer filtration vessel) which helps keep users drier than conventional solutions. By avoiding disassembling of the filtration system 100 (e.g., filter assembly), the person cleaning the filter structure 160 would not need to stop the cleaning process to search for, and address, leaks in a filtration system 100 (e.g., filtration assembly) after exposing a filter structure 160 to clean the filter structure 160.

In a filtration system 100 (e.g., filtration assembly), an agitator structure 140 is located in the filtration system 100 (e.g., filtration assembly) proximate the filter structure 160 (e.g., extending around an outer surface of the filter structure 160, disposed within the filter structure 160, etc.), with protrusions (e.g., filaments, wires, bristles, etc.) arranged on a surface (e.g., an interior surface, outer surface) of a hollow cylindrical agitator structure 140, or ring-shaped agitator structure 140, which then brush along the surface of a filter structure 160 in the filtration system 100 (e.g., a filtration assembly) to dislodge debris from the filter surface of the filter structure 160 into the water in the filtration system 100 (e.g., filtration assembly). In some embodiments, the water in the filtration system 100 (e.g., filtration assembly) is flowing across the surface of the filter structure 160 and out of an opening in the filtration system 100 (e.g., filtration assembly) (that is selectively covered by outlet structure 150) to flush the debris from the filtration system 100 (e.g., filtration assembly). In some embodiments, the water in the filtration system 100 (e.g., filtration assembly) is static until the filter structure 160 has been scrubbed substantially completely free of solid matter, and then the water and the suspended debris are flushed out of the filtration system 100 (e.g., filtration assembly).

In the filtration system 100 of the present disclosure, the actuation structure 130 (e.g., handle) and agitator structure 140 (e.g., agitator) are configured to magnetically couple to each other and the actuation structure 130 (e.g., handle) and agitator structure 140 (e.g., agitator), once magnetically coupled, move along a major axis of the housing structure 110 (e.g., filtration vessel) (e.g., rather rotating around the major axis at a fixed position along the major axis).

In a conventional filtration assembly, conventional rotary motion of the agitator may be impractical for cleaning a cylindrical filter in a filtration assembly because the rotation does not move the agitator along the major axis extending along the length of the filter. Further, electrical power used in conventional systems may not always available at a filtration assembly on a farm or ranch and carrying an electrical motor around to perform filter cleaning for several filtration assemblies may be quite difficult.

In some embodiments, a filtration system 100 includes or is a filtration vessel.

FIG. 2C illustrates the lid structure 120 (e.g., upper portion, vessel lid) of a filtration system 100 (e.g., filtration vessel, filtration system 100 of FIG. 1C, filtration system of FIGS. 2A-B), according to certain embodiments. The lid structure 120 (e.g., upper portion), the lid for the filtration vessel) may include a lid sidewall 102 with lower threaded portion (e.g., threads 103 on a surface of the lid sidewall 102) to hold the lid structure 120 to the housing structure 110 (e.g., body of the filtration system 100, lower portion). Lid structure 120 may connect directly to the housing structure 110 or indirectly (e.g., via an attachment ring 124). In some embodiments, the lower surface of the lid sidewall 102 forms a compression fit with the housing structure 110 (e.g., body of the lower portion of the filtration system 100)).

Lid structure 120 (e.g., upper portion) includes a channel portion 126 that extends downward from the top surface of the lid structure 120 (e.g., upper portion), where the channel portion 126 and/or channel 128 formed by channel portion 126 has a channel length L1 and a channel inner diameter CID. The upper end of the channel portion 126 and/or channel 128 forms an opening in the top surface of the lid structure 120 (e.g., upper portion), and is configured to receive an actuations structure 130 (e.g., handle) having at least one metallic component 132 (e.g., magnet) embedded therein. The opening at an end of the channel portion 126 and/or channel 128 proximal to the top surface of the lid structure 120 is opposite the bottom end 118 of the channel portion 126. Bottom end 118 of the channel portion 126 is sealed to prevent leakage into and out of the filtration system 100 (e.g., housing structure 110, lid structure 120).

In some embodiments, the lid structure 120 is manufactured by injection molding processes and assembled with the other components (e.g., housing structure 110, attachment ring 124, actuation structure 130, etc.) at a later time. By forming the lid structure 120 (e.g., upper portion) in a single injection molding process, the channel portion 126 forms an integral part of the lid structure 120 (e.g., upper portion) and there is no seam to leak where the channel portion 126 meets the top surface of lid structure 120.

In some embodiments, the lid structure 120 (e.g., upper portion) couples to (e.g., fits onto) a housing structure 110 (e.g., lower portion) of a filtration system 100 (e.g., filtration vessel) by a compression fit as the lid structure 120 (e.g., upper portion) flexes when fit onto the housing structure 110 (e.g., lower portion) of the filtration system 100 (e.g., filtration vessel). In an embodiment of the lid structure 120 (e.g., upper portion) which fits by compression alone, the threads (e.g., on the inner surface) of the lid sidewall 102 are absent.

According to some embodiments, the lid structure 120 (e.g., upper portion) includes a moldable material suitable for injection molding. In some embodiments, the moldable material comprises high density polyethylene (HDPE), polypropylene (PP), nylon, acrylic, polystyrene (PS), silicone, and/or a food-safe material suitable for storing food during food preparation or food handling.

FIG. 2D illustrates an actuation structure 130 (e.g., handle) for a filtration system 100 (e.g., filtration vessel), in accordance with certain embodiments. Actuation structure 130 (e.g., filtration handle) includes a handle portion 136 (e.g., grip) that may have a flat top end and an underside. In some embodiments, underside makes direct contact with top surface of lid structure 120 (e.g., upper portion). Actuation structure 130 (e.g., filtration handle) has a shaft 208 with a shaft diameter D1 and a shaft length L2. In some embodiments, shaft length L2 is larger than channel length L1. In some embodiments, shaft length L2 is larger than channel length L1 to provide clearance for a person's fingers when gripping handle portion 136 (e.g., handle grip) during a filtration process. In some embodiments, shaft length L2 is shorter than channel length L1. Embodiments where shaft length L2 is shorter than channel length L1 are so configured to accommodate agitator structures 140 having a large vertical dimension along the major axis of the channel.

In some embodiments, actuation structure 130 (e.g., filtration handle) includes two metallic components 132 (e.g., two magnets) embedded in the shaft 208. A midpoint of metallic component 132 (e.g., magnet) is at a distance H1 from the distal end 214 of shaft 208. A midpoint of a metallic component 132 (e.g., magnet) is at a distance H2 from the midpoint of a metallic component 132 (e.g., magnet) further from the distal end 214 of shaft 208, or at a distance H3 from the distal end 214 of shaft 208 (e.g., H1+H2=H3). In some embodiments, an actuation structure 130 (e.g., filtration handle) has two metallic components 132 (e.g., magnets) to promote easier cleaning of a filer structure 160 in a filtration system 100 (e.g., housing structure 110, filtration vessel) because each of the two metallic components 132 (e.g., magnets) can couple with an agitator structure 140 to allow the agitator structure 140 to mix with an upper portion of the liquid in the housing structure 110 (e.g., filtration vessel), or a lower portion of the liquid in the housing structure 110 (e.g., filtration vessel), while reducing the chance that the actuation structure 130 (e.g., filtration handle) will be accidentally pulled from the channel during a process of cleaning the filter structure 160. In some embodiments, the actuation structure 130 (e.g., filtration handle) includes a single metallic component 132 (e.g., magnet). In some embodiments, the single metallic component 132 (e.g., magnet), or the lower metallic component 132 (e.g., magnet, closer to distal end 214) is at the end of shaft 208 to allow the magnet to magnetically couple to an agitator structure 140 resting at the bottom of a housing structure 110 (e.g., filtration vessel lower portion).

According to some embodiments, the actuation structure 130 (e.g., filtration handle) includes a moldable material suitable for injection molding. In some embodiments, the moldable material includes high density polyethylene (HDPE), polypropylene (PP), nylon, acrylic, polystyrene (PS), silicone, and/or a food-safe material suitable for storing food during food preparation or food handling. According to some embodiments, actuation structure 130 (e.g., filtration handle) includes a rigid material to reduce the flexibility as the actuation structure 130 (e.g., filtration handle) is used to remove solid matter form the filter structure 160 (e.g., agitate contents of a housing structure 110). In some embodiments, the actuation structure 130 (e.g., filtration handle) includes, in addition to the metallic components 132 (e.g., magnets), a rigid core material to prevent flexing (e.g., of the actuation structure 130, of handle portion 136, etc.), and the metallic components 132 (e.g., magnets) and core material are coated by a second material (e.g., which is irrigation safe, which is food safe).

According to some embodiments, the handle portion 136 of actuation structure 130 (e.g., handle grip) is a flat disk. In some embodiments, the handle portion 136 of actuation structure 130 (e.g., handle grip) has a spherical shape. In some embodiments, the handle portion 136 of actuation structure 130 (e.g., handle grip) includes a ring set perpendicular to top surface of lid structure 120 (e.g., upper portion), such that a finger can fit in the ring to raise and lower at least a portion of the actuation structure 130 (e.g., handle) in the channel 128. In some embodiments, the actuation structure 130 (e.g., handle portion 136, handle grip) includes the same rigid core material into which the metallic components 132 (e.g., magnets) are placed, and is coated with the second material (e.g., food safe, irrigation safe, etc.). In some embodiments, the actuation structure 130 (e.g., handle portion 136, handle grip) includes the same rigid core material into which the one or more metallic components 132 (e.g., magnets) are placed, and is not coated with the second material (e.g., food safe material, irrigation safe material, etc.). Because the actuation structure 130 (e.g., filtration handle) does not come into contact with the contents of a housing structure 110 (e.g., filtration vessel) during filtration and cleaning of the filter structure 160, the food-safe and/or irrigation-safe covering material is an optional element of the actuation structure 130 (e.g., handle portion 136, filtration handle).

FIG. 2E illustrates a housing structure 110 (e.g., lower portion) of a filtration system 100 (e.g., filtration vessel), in accordance with certain embodiments. Housing structure 110 (e.g., lower portion) includes a sidewall 302, a flange 304, a top edge 306, and threads 308 (e.g., upper threaded portion). Threads 308 are configured to engage with threads 103 of an attachment ring 124 or lid structure 120. In some embodiments, threads 308 are omitted from the flange 304 because the flange comprises a sealing lip (see optional element 310) configured to form a compression fit with a lower surface of a lid structure 120 (e.g., filtration vessel lid) and/or attachment ring 124. Housing structure 110 (e.g., lower portion) includes an outlet 312 configured to couple with an outlet structure 150 (e.g., via threading, via friction fit, etc.) In some embodiments, outlet structure 150 is configured to be removed from housing structure 110 to allow filtered material (e.g., solid matter) to exit the housing structure 110. In some embodiments, outlet structure 150 is configured to open (e.g., is a valve that has an open position and a closed position) to allow filtered material (e.g., solid matter) to exit the housing structure 110. Housing structure 110 (e.g., lower portion) has a first diameter D2 at the level of the flange 304 and a second diameter D3 proximate the outlet 312. In some embodiments, D2=D3 such that the sidewall 302 is perpendicular to the outlet 312. In some embodiments, the sidewall 302 is perpendicular to the outlet 312 so that the agitator structure 140 located in the housing structure 110 (e.g., lower portion) has a constant clearance distance between the agitator structure 140 and the inner surface of sidewall 302, to provide enhanced cleaning of filter structure 160. In some embodiments, D3 is smaller than D2, such that at least a portion of the sidewall 302, measured from the flange to the outlet 312, is angled (e.g., tapered). In some embodiments, the sidewall is angled (e.g., tapered) so that the outlet 312 has a smaller diameter than the filter structure 160.

In some embodiments, the housing structure 110 (e.g., lower portion) includes a moldable material suitable for injection molding. In some embodiments, the moldable material comprises high density polyethylene (HDPE), polypropylene (PP), nylon, acrylic, polystyrene (PS), silicone, and/or a food-safe or irrigation-safe material. In some embodiments, housing structure 110 (e.g., lower portion) is substantially transparent (e.g., is a substantially transparent plastic, a substantially transparent glass, etc.).

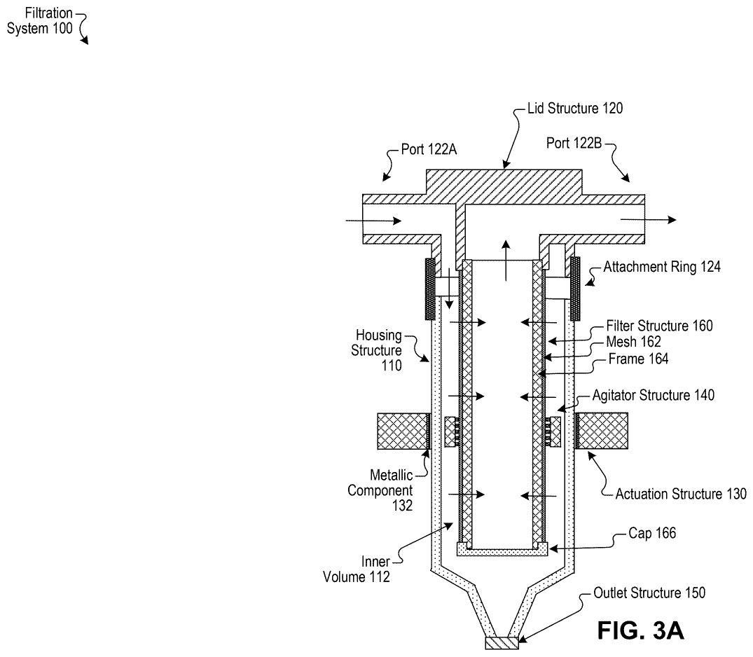

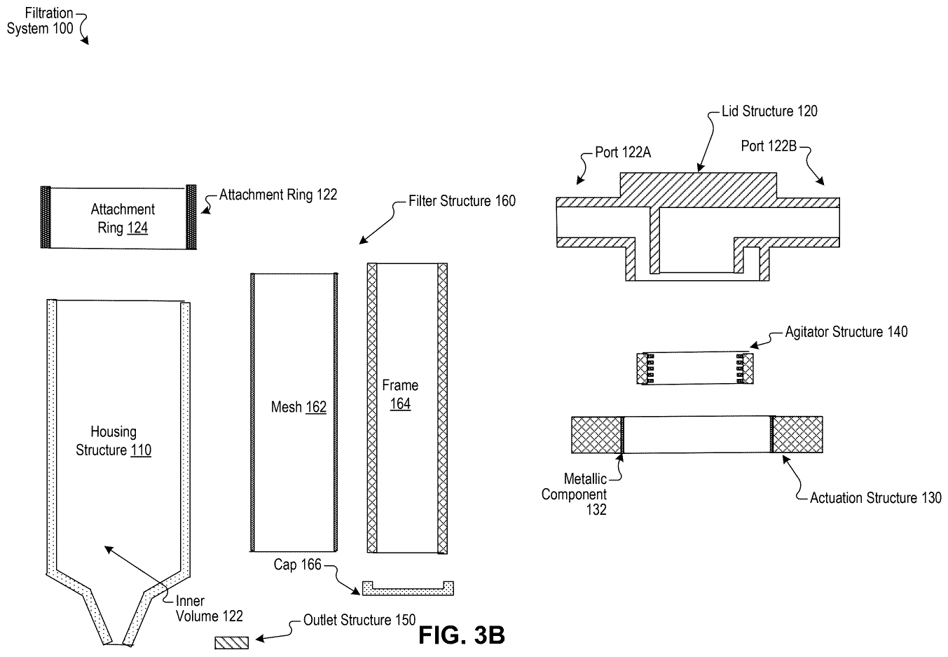

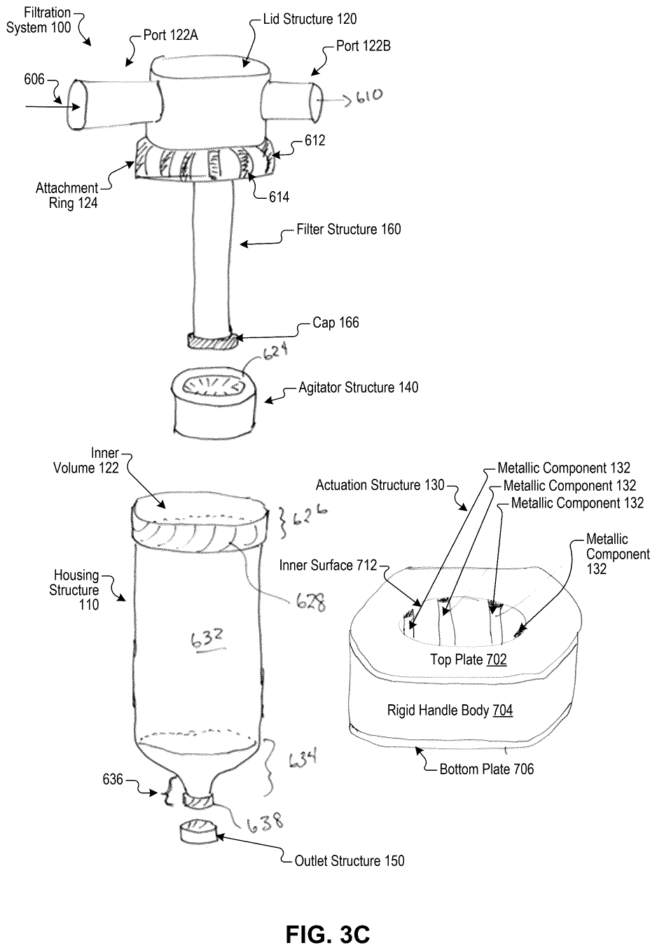

FIGS. 3A-C illustrate filtration systems 100, according to certain embodiments. FIG. 3A illustrates a filtration system 100 that is assembled. FIG. 3B illustrates a filtration system 100 that is disassembled. FIG. 3C illustrates an exploded view of a filtration system 100.

Referring to FIGS. 3A-B, a filtration system 100 includes housing structure 110, lid structure 120, actuation structure 130, agitator structure 140, outlet structure 150, and filter structure 160.

The housing structure 110 includes a first distal end coupled to the lid structure 120 (e.g., directly or via attachment ring 124) and a second distal end coupled to outlet structure 150 (e.g., via threading, friction fit).

The lid structure 120 includes a port 122A to receive fluid flow and provide the fluid flow into interior volume 112 of housing structure 110, through filter structure 160 into inner channel of filter structure 160, and through port 122B to exit the filtration system 100.

The actuation structure 130 includes one or more metallic components 132 (e.g., magnets) and is disposed around the housing structure 110. The actuation structure is configured to be moved (e.g., manually, via a motor, etc.) relative to the housing structure 110 (e.g., about the central axis of the housing structure 110).

The agitator structure 140 is disposed in the inner volume 112 of the housing structure 110 and includes one or more protrusions directed towards the filter structure 160. The agitator structure 140 is magnetically coupled (e.g., is or includes one or more metallic components or one or more magnets) to the agitator structure 140.

The outlet structure 150 is coupled to the second distal end of the housing structure 110. In some embodiments, the outlet structure 150 is configured to be removed to allow material (e.g., solid matter, sediment, etc.) to be removed from the inner volume 112. In some embodiments, the outlet structure 150 (e.g., a valve) is configured to be opened to allow material (e.g., solid matter, sediment, etc.) to be removed from the inner volume 112.

The filter structure 160 has a first distal end that is coupled to the lid structure 120 and a second distal end that is coupled to a cap 166. The cap 166 may prevent solid matter from passing into the inner channel of the filter structure 160. The cap 166 may form openings (e.g., substantially the same size as the openings formed by the mesh 162) to allow passage of liquid and to prevent passage of solid material. The cap 166 may be offset from the housing structure 110. The filter structure 160 may include a mesh 162 and a frame 164. The frame 164 may provide a rigid structure (e.g., may be coupled to lid structure 120 and cap 166 via threading and/or friction fit). The mesh 162 may prevent passage of solid matter through the filter structure 160.

Referring to FIG. 3C, filtration system 100 (e.g., filter assembly) includes a filter structure 160 (e.g., filter) attached to a lid structure 120 (e.g., filter head). Lid structure (e.g., filter head) a port 122A (e.g., inlet opening) through which an inlet flow 606 of liquid (e.g., water) enters the filtration system 100 (e.g., filter assembly). Lid structure 120 (e.g., filter head) also has a port 122B (e.g., outlet opening) through which an outlet flow 610 of filtered liquid exits the filtration system 100 (e.g., filter assembly). The inlet flow 606 of liquid enters the filtration system 100 via port 122A, passes over the outer surface of filter structure 160, and enters the filter structure 160 through holes formed by the filter structure 160, before being forced, by additional liquid in the inlet flow 606, up into the lid structure 120 (e.g., filter head) and through the port 122B (e.g., outlet opening) as outlet flow 610 of liquid. Thus, material (e.g., sediment) entrained with the inlet flow 606 of liquid is trapped against the outer surface of filter structure 160 during operation of the filtration system 100.

In some embodiments, filter structure 160 (e.g., mesh 162) is a metallic filter or a piece of metal (e.g., steel) that has holes punched therein to allow the inlet water flow to pass through, while screening out debris larger than the diameter of the holes punched in the filter metal. In some embodiments, filter structure 160 (e.g., mesh 162) is a plastic filter that has holes punched therein to allow water to flow through while screening out debris larger than the diameter of the holes. In some embodiments, filter structure 160 includes mesh 162 that is a porous membrane that extends over a frame 164 (e.g., support structure) to hold the mesh 162 (e.g., porous membrane) taut. In some embodiments, the filter structure 160 (e.g., frame 164) screws onto the lid structure 120 (e.g., filter head) or onto the interior end of the port 122B (e.g., outlet opening). In some embodiments, the filter structure 160 includes a mesh 162 (e.g., porous membrane) held onto the interior end of port 122B (e.g., outlet opening) (e.g., by a worm drive or screw clamp) and the frame 164 (e.g., support structure) is fastened to the interior end of the port 122B (e.g., outlet opening) separately from the mesh 162 (e.g., porous membrane) of the filter structure 160. In some embodiments, a filter structure 160 including a mesh 162 (e.g., porous membrane) and frame 164 (e.g., support structure) are used for liquid flow that meets a lower flow rate (e.g., low flow rate applications, a first threshold flow rate) and a filter structure 160 that includes a metallic or plastic filter that has holes punched therein is used for liquid flow that meets a higher flow rate (e.g., high flow rate applications, a second threshold flow rate). In some embodiments, multiple filtration systems 100 are used in series in a piping system, to screen out successively smaller debris as the flowing water passes through the piping system.

Filtration system 100 (e.g., filter assembly) includes an agitator structure 140 which fits around the outer surface of filter structure 160. Agitator structure 140 includes a ferromagnetic material that is magnetically coupled to an actuation structure 130 (e.g., a handle) positioned around the housing structure 110 to clean the filter structure 160 by moving agitator structure 140 along the length of filter structure 160 as the actuation structure 130 (e.g., handle) is moved along the length of the housing structure 110 (e.g., filter assembly outer wall 623). Agitator structure 140 further includes an open cylinder having protrusions 624 (e.g., filaments) located on an interior surface of the open cylinder. Protrusions 624 (e.g., filaments) are configured to make contact with the outer surface of filter structure 160 and dislodge material (e.g., debris, contaminants, solid matter, algae, shells, etc.) located on the outer surface of filter structure 160. In some embodiments, protrusions 624 (e.g., filaments) are metallic filaments which brush against a rigid filter structure 160 (e.g., a rigid filter, a plastic or metal filter with holes punched therein). In some embodiments, protrusions 624 (e.g., filaments) are plastic and/or polymeric filaments that brush across the surface of the filter structure 160 (e.g., mesh 162) to dislodge both material (e.g., debris, solid matter, etc.) held against the outer surface of the filter structure 160 by the flow of water and to clean the outer surface of the filter structure 160.

In some embodiments, the protrusions 624 (e.g., filaments) have a diameter smaller than the openings in a rigid embodiment of a filter structure 160, and a length greater than the distance between the inner surface of the agitator structure 140 and the outer surface of the filter structure 160, and are able to extend slightly into the holes formed by the filter structure 160. The protrusions 624 (e.g., filaments) of an agitator structure 140 may be used to clean the inner edge of the holes formed by a filter structure 160 in addition to the outer surface of the filter structure 160.

In some embodiments, the filter structure 160 includes a mesh 162 (e.g., porous membrane) held over (e.g., disposed around, secured to) a frame 164 (e.g., support structure) and the protrusions 624 (e.g., filaments) of the agitator structure 140 are configured to brush along the surface of the mesh 162 (e.g., porous membrane) and to flex the mesh 162 (e.g., porous membrane) without puncturing the mesh 162 (e.g., membrane). The combination of surface contact and flexing of mesh 162 (e.g. membrane flexing) may promote removal of material (e.g., debris, solid matter, etc.) lodged partially or completely in the mesh 162 (e.g., membrane) without puncturing the mesh 162 (e.g., membrane).

In some embodiments, the filter structure 160 includes a pleated porous material, and the protrusions 624 (e.g., filaments) include rigid or flexible filaments or fins which fit against the outer surface of the pleated porous material to dislodge materials (e.g., solid matter, sediment, etc.) trapped in the pleats, to lift up materials on the surface of the pleated porous material, and to apply pressure against the pleated porous material to dislodge materials partially or completely embedded in the porous material during agitation by the agitator structure 140.

In some embodiments, a filtration system 100 (e.g., filter assembly) is configured to receive an external flow of liquid (e.g., water) to clean the filter structure 160. In some examples, a flow of clean water supplied into the filtration system 100 (e.g., filter assembly) through the port 122B (e.g., outlet opening) is supplied to an interior surface of the filter structure 160. In some embodiments, the agitator structure 140 is magnetically coupled to the actuation structure 130 (e.g., handle) and is moved along the length of the filter structure 160 to enhance cleaning of the filter structure 160 during a reverse flow of water through the filtration system 100 by (e.g., flexing the filter during the reverse flow of water).

Filtration system 100 (e.g., filter assembly) further includes an outer wall 632 (e.g., of housing structure 110) which fastens to the lid structure 120 (e.g., filter head) at first flange 612 (e.g., via attachment ring 124). First flange 612 includes threads 614 along an interior surface of the first flange just below lid structure 120 (e.g., filter head). Outer wall 632 includes a second flange 626 that has a set of complimentary threads 628 along an outer surface of the second flange 626, configured to interleaf with threads 614 of first flange 612.

Outer wall 632 may further include a pinch section 634 (e.g., tapered portion) where the outer wall 632 tapers down to a drain section 636, having a drain opening 638 and an outlet structure 150 (e.g., drain cap). In some embodiments, drain opening 638 is opened during operation of the agitator structure 140 to clean filter structure 160 (such as, when there is an inlet flow 606 of liquid (e.g., water) moving through the filter structure 160). In some embodiments, the drain opening 638 is opened after cleaning of a filter structure 160 using agitator structure 140, and a flow of water (e.g., an inlet flow 606 of water, or a reverse flow of water as described above) is applied to the filtration system 100 (e.g., filter assembly) after the agitator structure 140 has been used to clean the filter structure 120. In some embodiments, outlet structure 150 (e.g., drain cap) is threaded to mate with matching threads on the drain opening 638 at the distal end of outer wall 632 of housing structure 110. In some embodiments, the agitator structure 140 remains on filter structure 120 at all times. In some embodiments, agitator structure 120 rests at the bottom of outer wall 632 in either drain section 636 or pinch section 634, and, after magnetically coupling to the actuator structure 130 (e.g., handle), is brought into position around the outer surface of filter structure 140. In some embodiments, the cap 166 (e.g., filter end) is porous and provides additional filtration. In some embodiments, cap 166 (e.g., filter end) is solid and tapered to allow easier access when positioning the agitator around the outer wall of filter 618.

Actuation structure 130 (e.g., magnetic handle, handle) for filtration system 100 (e.g., filter assembly) may include a rigid handle body 704 with a top plate 702 and a bottom plate 706. Actuation structure 130 (e.g., magnetic handle) may further include an inner surface 712 which extends from the top plate 702 to the bottom plate 706 that has a large enough diameter to allow the actuation structure 130 (e.g., handle) to fit around the housing structure 110 (e.g., fit around outer wall 632 of housing structure 110). In some embodiments, the inner surface 712 forms a cylindrical opening, a square opening, or a hexagonal opening. In some embodiments, the shape of the opening formed by inner surface 712 substantially corresponds to the outer profile of an outer wall of the filtration system 100 (e.g., housing structure 110).

In some embodiments, top plate 702 and bottom plate 706 are fastened to the rigid handle body 704 by screws or other fasteners. In some embodiments, top plate 702 and bottom plate 706 fasten to rigid handle body 704 by flexible snap connectors. In some embodiments, the top plate 702 and bottom plate 706 fasten to the rigid handle body 704 by screwing the top plate 702 and the bottom plate 706 to the rigid handle body 704. In some embodiments, actuation structure 130 (e.g., magnetic handle) is a single piece of material with no top plate or no bottom plate. In some embodiments, the rigid handle body 704 has holes (e.g., cylindrical holes) therein into which metallic components 132 (e.g., magnets) are inserted. In some embodiments, the rigid handle body 704 has holes (e.g., fully cylindrical holes) extending into the rigid handle body 704 from a top surface and/or a bottom surface of the rigid handle body 704. In some embodiments, the rigid handle body has recesses in inner surface 712, configured to secure metallic components 132 (e.g., magnets) placed therein. In some embodiments, a protective sleeve (not shown) is placed on inner surface 712 to secure metallic components 132 (e.g., magnets) in the recesses in inner surface 712 and to protect an outer surface of the housing structure 110 (e.g., filter housing outer wall) from being scratched or damaged by the metallic components 132 (e.g., magnets) or other parts of the actuation structure 130 (e.g., magnetic handle) that make contact with the outer surface of a housing structure 110 (e.g., filter housing outer wall).

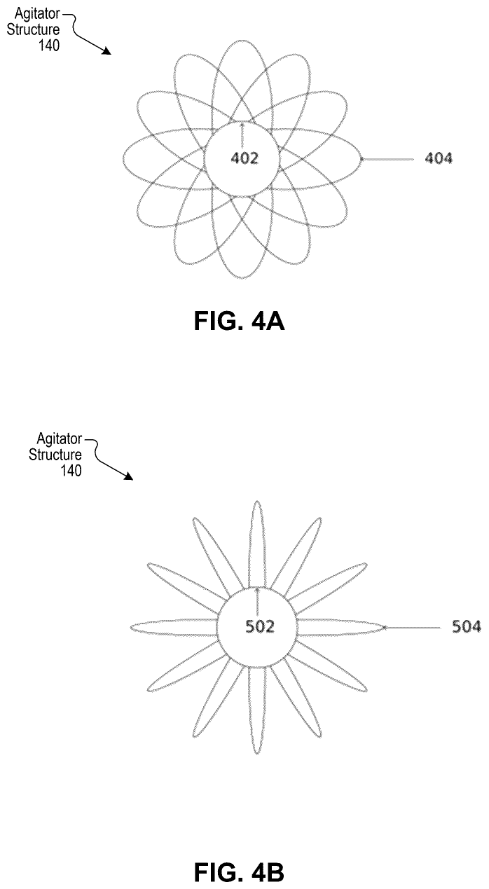

FIGS. 4A-B illustrate agitator structures 150 of filtration systems 100 (e.g., filtration vessels), according to certain embodiments.

Referring to FIG. 4A, agitator structure 140 includes a core 402 and protrusions 404 (e.g., filtration filaments. Core 402 includes an open cylinder of ferromagnetic material which is configured to magnetically couple to a magnet in shaft 208 of the actuation structure 130. The protrusions 404 (e.g., filtration filaments) may form loops that extend out from the outer surface of core 402 and cross adjacent protrusions 404 (e.g., filaments) near the point of attachment of each protrusions 404 (e.g., filtration filament) with the outer surface of core 402.

In some embodiments, agitator structure 140 includes stainless steel or a food-safe or irrigation-safe material. In some embodiments, the protrusions 404 (e.g., filtration filaments) take different shapes, including circles, ovals, and/or rectangles as they extend away from, and return to, core 402.

Referring to FIG. 4B, agitator structure 140 for a filtration system 100 (e.g., filtration vessel) includes a core 502 and protrusions 504 (e.g., filtration fins). In some embodiments, the protrusions 504 (e.g., fins) include a same material as the core 502. In some embodiments, the protrusions 504 (e.g., fins) include flat fins. In some embodiments, the protrusions 504 (e.g., fins) include tilted fins. Core 502 includes a ferromagnetic material which can magnetically couple with at least one magnet in a shaft 208 of the actuation structure 130 (e.g., filtration handle) introduced into the channel 128 of the lid structure 120 (e.g., upper portion) of the filtration system 100 (e.g., filtration vessel).

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

The terms “over,” “under,” “between,” “disposed on,” and “on” as used herein refer to a relative position of one material layer or component with respect to other layers or components. For example, one layer disposed on, over, or under another layer may be directly in contact with the other layer or may have one or more intervening layers. Moreover, one layer disposed between two layers may be directly in contact with the two layers or may have one or more intervening layers. Similarly, unless explicitly stated otherwise, one feature disposed between two features may be in direct contact with the adjacent features or may have one or more intervening layers.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion.

Reference throughout this specification to “one embodiment,” “an embodiment,” or “some embodiments” means that a particular feature, structure, or characteristic described in connection with the embodiment is included in at least one embodiment. Thus, the appearances of the phrase “in one embodiment,” “in an embodiment,” or “in some embodiments” in various places throughout this specification are not necessarily all referring to the same embodiment. In addition, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Also, the terms “first,” “second,” “third,” “fourth,” etc. as used herein are meant as labels to distinguish among different elements and can not necessarily have an ordinal meaning according to their numerical designation. When the term “about,” “substantially,” or “approximately” is used herein, this is intended to mean that the nominal value presented is precise within ±10%.

Although the operations of the methods herein are shown and described in a particular order, the order of operations of each method may be altered so that certain operations may be performed in an inverse order so that certain operations may be performed, at least in part, concurrently with other operations. In another embodiment, instructions or sub-operations of distinct operations may be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

The drawings depict one or more implementations of the claimed subject matter and are provided to demonstrate one or more examples of embodiments of the claimed subject matter. Persons having ordinary skill in the art will recognize that these embodiments are one of several possible embodiments, and are representative, and not limiting, in nature. In the drawings and specification, like reference numerals refer to the same or similar elements.

Throughout the descriptions provided herein, a single identifying numeral is used to describe an element of the described embodiments of the claimed subject matter and is intended to represent similar elements found in similar embodiments.

It should be noted that various changes and modifications to the presently preferred embodiments described herein will be apparent to persons who are skilled in the art. Such changes and modifications are within the scope of the subject matter described herein, and do not deviate from the spirit and scope of the present disclosure and do not diminish the benefits derived therefrom.

What is claimed is:

1. A filtration system comprising:
a filter structure forming an inner channel, the filter structure being configured to remove solid matter from liquid;
a lid structure comprising a first port and a second port;
a housing structure forming an inner volume, the filter structure being disposed in the inner volume, the housing structure comprising a first distal end configured to releasably attach to the lid structure;
an actuation structure configured to be moved by a user relative to the housing structure, the actuation structure comprising one or more metallic components; and
an agitator structure disposed in the housing structure, the agitator structure and the actuation structure being magnetically attracted to each other, the agitator structure being configured to remove the solid matter from the filter structure responsive to the actuation structure being moved relative to the housing structure.

2. The filtration system of claim 1, wherein responsive to the first port providing the liquid into the inner volume of the housing structure, the liquid passes through the filter structure and exits the second port.

3. The filtration system of claim 1, wherein the first distal end of the housing structure is attached to the lid structure via an attachment ring.

4. The filtration system of claim 1, wherein:
the actuation structure is configured to be disposed around the housing structure; and
the agitator structure comprises protrusions configured to clean an outer surface of the filter structure.

5. The filtration system of claim 4, wherein:
the filter structure comprises a first filter distal end releasably attached to the lid structure and a second filter distal end releasably attached to a cap that is offset from the housing structure; and
the liquid is between the housing structure and the filter structure prior to passing through the filter structure.

6. The filtration system of claim 4 further comprising an outlet structure configured to releasable attach to a second distal end of the housing structure, wherein the outlet structure is to be removed to remove the solid matter from the inner volume of the housing structure responsive to the actuation structure being moved relative to the housing structure.

7. The filtration system of claim 1, wherein:
the lid structure comprises a channel portion forming a channel, the channel portion comprising a closed bottom surface; and
the actuation structure comprises:
an elongated portion configured to extend into the channel formed by the channel portion of the lid structure, the elongated portion comprising the one or more metallic components; and
a handle portion configured to be used to move the elongated portion within the channel.

8. The filtration system of claim 7, wherein:
the agitator structure is configured to be disposed around the elongated portion; and
the agitator structure comprises protrusions configured to clean an inner surface of the filter structure.

9. The filtration system of claim 7, wherein:
the filter structure comprises a first filter distal end releasably attached to the lid structure and a second filter distal end sealed to the housing structure; and
the liquid is between the channel portion of the lid structure and the filter structure prior to passing through the filter structure.

10. The filtration system of claim 7 further comprising an outlet structure configured to releasable attach to a second distal end of the housing structure, wherein the outlet structure is to be removed to remove the solid matter from within the filter structure responsive to the actuation structure being moved relative to the housing structure.

11. A filtration system comprising:
an actuation structure configured to be disposed around a housing structure, wherein the actuation structure is configured to be moved by a user relative to the housing structure, the actuation structure comprising one or more metallic components; and
an agitator structure configured to be disposed around a filter structure in the housing structure, the agitator structure comprising protrusions configured to clean an outer surface of the filter structure, the agitator structure and the actuation structure being magnetically attracted to each other, the agitator structure being configured to remove solid matter from the filter structure responsive to the actuation structure being moved relative to the housing structure.

12. The filtration system of claim 11, wherein:
the filter structure forms an inner channel, the filter structure being configured to remove the solid matter from liquid;
a lid structure comprises a first port and a second port; and
the housing structure comprises a first distal end configured to releasably attach to the lid structure.

13. The filtration system of claim 11, wherein:
the filter structure comprises a first filter distal end configured to releasably attach to a lid structure and a second filter distal end releasably attached to a cap that is offset from the housing structure; and
liquid is between the housing structure and the filter structure prior to passing through the filter structure.

14. The filtration system of claim 11, wherein:
an outlet structure is configured to releasably attach to a second distal end of the housing structure; and
the outlet structure is to be removed to remove the solid matter from an inner volume of the housing structure responsive to the actuation structure being moved relative to the housing structure.

15. The filtration system of claim 11, wherein:
the actuation structure has a substantially circular inside perimeter; and
outer perimeter and inner perimeter of the agitator structure are substantially circular.

16. A filtration system comprising:
a lid structure comprising a first port, a second port, and a channel portion forming a channel, the channel portion comprising a closed bottom surface;
an actuation structure comprising:
an elongated portion configured to extend into the channel formed by the channel portion of the lid structure, the elongated portion comprising one or more metallic components; and
a handle portion configured to be used to move the elongated portion within the channel; and
an agitator structure configured to be disposed around the elongated portion in a housing structure, the agitator structure comprising protrusions configured to clean an inner surface of a filter structure disposed in the housing structure, the agitator structure and the actuation structure being magnetically attracted to each other, the agitator structure being configured to remove solid matter from the filter structure responsive to the actuation structure being moved relative to the housing structure.

17. The filtration system of claim 16, wherein:
the filter structure forms an inner channel, the filter structure being configured to remove the solid matter from liquid; and
the housing structure comprising a first distal end configured to releasably attach to the lid structure.

18. The filtration system of claim 16, wherein:
the filter structure comprises a first filter distal end releasably attached to the lid structure and a second filter distal end sealed to the housing structure; and
liquid is between the channel portion of the lid structure and the filter structure prior to passing through the filter structure.

19. The filtration system of claim 16, wherein:
an outlet structure is configured to releasably attach to a second distal end of the housing structure; and
the outlet structure is to be removed to remove the solid matter from within the filter structure responsive to the actuation structure being moved relative to the housing structure.

20. The filtration system of claim 16, wherein outer perimeter and inner perimeter of the agitator structure are substantially circular.
